(19) United States
(12) Patent Application Publication
(10) Pub. No.: US 2006/0153507 A1
(43) Pub. Date: Jul. 13, 2006

(54) Modular optical devices compatible with legacy form factors

(76) Inventors: Chris K. Togami, San Jose, CA (US); Gary Sasser, San Jose, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/134,530

(22) Filed: May 20, 2005

Related U.S. Application Data
(60) Provisional application No. 60/573,292, filed on May 21, 2004.

(51) Int. Cl. G02B 6/36

(52) U.S. Cl. 385/93

(57) ABSTRACT

The present invention relates to modular optical devices compatible with legacy form factors, for example, SFF, SFP, and XFP form factors. A housing contains optical components including a lens block, a fabricated package, at least one lens pin, and a substrate. The lens block is configured to receive one or more lens pins. The fabricated package is mechanically coupled to the lens block and includes a light source and/or a light detector and a connector for coupling the fabricated package to the substrate. The at least one lens pin is mechanically coupled to the lens block for directing optical signals between the light source and/or light detector and external components. The substrate is mechanically coupled to the fabricated package and the housing and electrically connected to the light source and/or light detector such that substrate circuitry can electrically interoperate with the light source and/or light detector.

### CROSS-REFERENCE TO RELATED APPLICATIONS

The present invention claims priority to U.S. Provisional Patent Application Ser. No. 60/573,292, entitled “Modular Optical Devices Compatible With Legacy Form Factors”, filed on May 21, 2004, the entire contents of which are incorporated herein by reference.

### BACKGROUND OF THE INVENTION

1. The Field of the Invention

The present invention is generally related to optical devices used in fiber optic communications systems. More particularly, the present invention provides for modular optical devices that are compatible with legacy form factors.

2. The Relevant Technology

Fiber optic technology is increasingly employed as a method by which information can be reliably transmitted via a communications network. Networks employing fiber optic technology are known as optical communications networks, and are marked by high bandwidth and reliable, high-speed data transmission.

Optical communications networks employ optical transceivers in transmitting information via the network from a transmission node to a reception node. Generally, such optical transceivers implement both data signal transmission and reception capabilities. For example, a transmitter portion of a transceiver is configured to convert an incoming electrical data signal into an optical data signal and a receiver portion of the transceiver is configured to convert an incoming optical data signal into an electrical data signal.

More particularly, an optical transceiver at the transmission node receives an electrical data signal from a network device, such as a computer, and converts the electrical data signal to a modulated optical data signal using an optical transmitter such as a laser. The optical data signal can then be transmitted in a fiber optic cable via the optical communications network to a reception node of the network. At the reception node, the optical data signal is received at another optical transceiver that uses a photo detector, such as a photodiode, to convert the received optical data signal back into an electrical data signal. The electrical data signal is then forwarded to a host device, such as a computer, for processing.

Generally, multiple components are designed to accomplish different aspects of these functions. For example, an optical transceiver can include one or more optical subassemblies (“OSA”) such as a transmit optical subassembly (“TOSA”), and a separate receive optical subassembly (“ROSA”). Typically, each OSA is created as a separate physical entity, such as a hermetically sealed cylinder that includes one or more optical sending or receiving components, as well as electrical circuitry for handling and converting between optical and electrical signals. Within the optical transceiver, each OSA generally includes electrical connections to various additional components such as a transceiver substrate, sometimes embodied in the form of a printed circuit board (“PCB”). OSAs in a conventional transceiver are generally oriented such that a longitudinal axis defined by the OSA is substantially parallel to the transceiver substrate.

The transceiver substrate can include multiple other active circuitry components particularly designed to drive or handle electrical signals sent to or returning from one or more of the OSAs. Accordingly, such a transceiver substrate will usually include a number of electrical transmission lines with the one or more OSAs. Such connections may include “send” and “receive” data transmission lines for each OSA, one or more power transmission lines for each OSA, and one or more diagnostic data transmission lines for each OSA.

These transmission lines are connected between the transceiver substrate and the OSA using different types of electrical connectors, examples of which include an electrical flex circuit, a direct mounting connection between conductive metallic pins extending from the OSA and solder points on the PCB, and a plug connection that extends from the PCB and mounts into electrical extensions from an OSA. A separate electrical connector is typically used for each OSA. For example, a first flex circuit can be used to connect a TOSA to a substrate and a second flex circuit can be used to connect a ROSA to the substrate. Thus, at least four different components, for example, a TOSA and corresponding flex circuit and a ROSA and corresponding flex circuit, must typically be electrically and mechanically coupled to a substrate when a transceiver is assembled.

As part of ongoing efforts to uniformly reduce the size of optical transceivers and other components, manufacturing standards such as the small form factor (“SFF”), small form factor pluggable (“SFP”), and 10 gigabit small form factor pluggable (“XFP”) standards have been developed. For example, an SFF or SFP optical transceiver can be used to provide an interface between an optical cable and a standard network cable, such as an Ethernet cable for example, that plugs into a computer system.

Accordingly, TOSAs, ROSAs, and corresponding connectors are often designed for use in transceivers with these form factors. However, manufacturing components for these form factors separately and then combining the components into a transceiver is relatively expensive. For example, separate tooling may be needed for TOSAs, ROSAs, and connectors, respectively. Further, when an assembled transceiver fails, either during testing or in operation, it is typically cheaper to replace the transceiver than attempt to repair the transceiver. Discarding a failed transceiver, especially during testing, can lead to waste.

For example, individual components are typically tested before being assembled into a transceiver. However, testing individual components provides no guarantee that the components will appropriately interoperate. Thus, assembled transceivers are also typically tested to determine if the components do appropriately interoperate. Unfortunately, if less than all, or even only one, of the individual components causes a transceiver to operate inappropriately (or fail tests), the whole transceiver may be discarded. Thus, some components that were functioning as intended are wasted. For example, a complete transceiver may be discarded if a TOSA is not operating appropriately, even when a corresponding ROSA is operating appropriately. Accordingly, what would be advantageous are reduced cost optical transceivers that facilitate efficient use of component resources.

### BRIEF SUMMARY OF THE INVENTION

The foregoing problems with the prior state of the art are overcome by the principles of the present invention, which are directed to modular optical devices compatible with legacy form factors. An optoelectronic device includes an external housing, for example, of an SFF, SFP, or XFP form factor. The external housing contains optical components including a lens block, a fabricated package, at least one lens pin, and a substrate. The lens block is configured such that the one or more lens pins can mechanically couple to the lens block and such that the lens block can mechanically couple to the fabricated package. The fabricated package is mechanically coupled to the lens block and includes a light source and/or a light detector and a connector portion for connecting the fabricated package to a substrate. The at least one lens pin is mechanically coupled to the lens block for directing optical signals between the light source and/or light detector and at least one corresponding external component. The substrate is mechanically connected to the fabricated package and the external housing and electrically connected to the light source and/or light detector such that circuitry on the substrate can electrically interoperate with the light source and/or light detector.

Additional features and advantages of the invention will be set forth in the description that follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates components of an example modular optical device.

FIG. 2 illustrates an example of an assembled modular optical device package with a formed lead frame.

FIG. 3 illustrates an example view of an assembled modular optical device included in a transceiver.

FIG. 4 illustrates an example view of various transceivers, which can include assembled modular optical devices, positioned on a printed circuit board assembly.

### DETAILED DESCRIPTION OF THE PREFERRED EMBODIMENTS

The present invention relates to modular optical devices compatible with legacy form factors. An optoelectronic device includes an external housing, for example, of an SFF, SFP, or XFP form factor. The external housing contains optical components including a lens block, a fabricated package, at least one lens pin, and a substrate. The lens block is configured such that the one or more lens pins can mechanically couple to the lens block and such that the lens block can mechanically couple to the fabricated package. The fabricated package is mechanically coupled to the lens block and includes a light source and/or a light detector and a connector portion for connecting the fabricated package to a substrate. The at least one lens pin is mechanically coupled to the lens block for directing optical signals between the light source and/or light detector and at least one corresponding external component. The substrate is mechanically connected to the fabricated package and the external housing and electrically connected to the light source and/or light detector such that circuitry on the substrate can electrically interoperate with the light source and/or light detector.

In general, embodiments of the present invention describe optoelectronic devices (e.g., optical transceivers) that can be integrated within the relatively small physical envelopes defined by compact components. Embodiments of the present invention can interoperate with a desktop computer, a laptop computer, or other similar computer system, while maintaining compliance with applicable operational and performance standards.

As used herein, “OSA” refers to any one of a transmit optical subassembly (“TOSA”) or a receive optical subassembly (“ROSA”). Further, a “substrate” refers to a printed circuit board (“PCB”) having electrically conductive elements such as circuit traces for transmitting power and/or communication signals between components of a modular optical device and another system or device, such as a computer system. A transceiver PCB (or transceiver substrate) can include circuits, devices and systems for facilitating the operation and control of components of an optoelectronic device. Such circuits, devices and systems include, but are not limited to, a laser driver, a post amplifier, and transimpedance amplifier.

Embodiments of the present invention include an external housing, for example, of a SFF, SFP, or XFP form factor. The external housing can be of a material, such as, for example, metal, that provides an appropriate barrier (e.g., physical, EMI, and ESD protection) for components included within the external housing. The external housing can contain an external connector for mechanically and electrically coupling the external housing to other components, such as, for example, a Host Bus Adapter (“HBA”) or other printed circuit board assembly (“PCBA”).

Embodiments of the present invention include a lens block that is configured such that one or more lens pins can mechanically couple to the lens block and such that the lens block can mechanically couple to a fabricated package. Accordingly, a modular optical device can include a lens block, a fabricated package, and one or more lens pins.

The fabricated package can include a light source (e.g., a vertical cavity surface emitting laser (“VCSEL”)) and/or light detector (e.g., photodiode) as well as corresponding openings for transmitting and receiving optical signals. The fabricated package can also include a lead frame, for example, in a formed or thru hole pin configuration, for connecting (e.g., surface mounting) the fabricated package to a PCB, such as, for example, a transceiver substrate.

Configurations of the lens block can include receptacles for accepting one or more lens pins. For example, a transmission lens pin, a reception lens pin, or a combination of transmission lens pins and/or reception lens pins can be mechanically coupled to the lens block. Lens pins mechanically coupled to the lens block can provide appropriate receptacles for receiving external optical connections. Lens pins can include lenses that focus optical signals.

Accordingly, a lens pin can direct a generated optical signal from the lens block to an external component (e.g., an optical cable) or can direct a received optical signal from an external component to the lens block. For example, an optical signal generated at a laser in the fabricated package can be transferred through the lens block, transferred through a lens in a corresponding lens pin, to a corresponding optical cable. Likewise, an optical signal received from an optical cable can be transferred through a lens in a corresponding lens pin, transferred through the lens block, into a corresponding photodiode in the fabricated package.

Embodiments of the present invention include a substrate, such as, for example, a PCB. A PCB can be part of an electronic circuit designed to include active and/or passive circuitry components for driving a light source (e.g., a laser driver), converting a received light signal (e.g., transimpedance amplifier), or for implementing other optical signal processing. The fabricated package can be electrically coupled to the substrate such that a light source and/or light detector in the fabricated package can electrically interoperate with circuitry on the substrate.

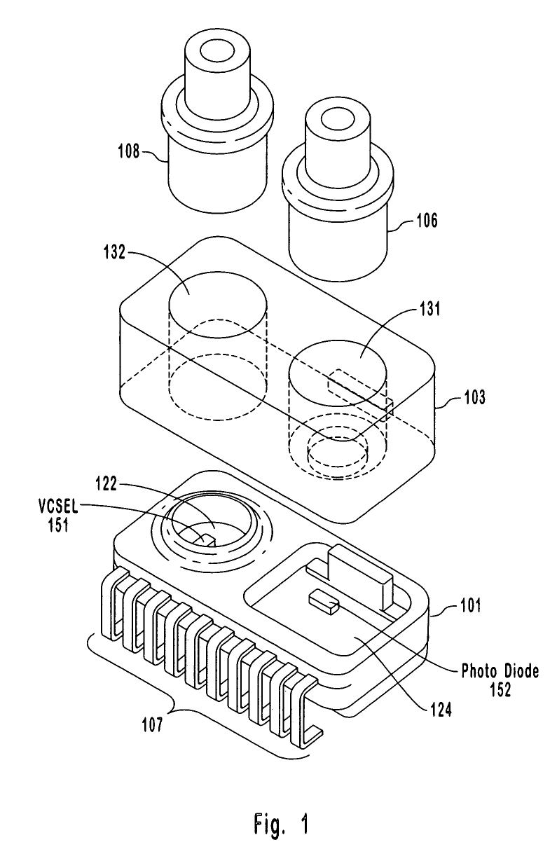

Referring now to FIG. 1, FIG. 1 illustrates components of an example modular optical device. Generally, components similar to those in FIG. 1 can be used in modular optical devices of various form factors, including, but not limited to, an SFF, SFP, and XFP optical transceiver. The foregoing are exemplary however, and modular optical devices can be implemented in various other forms as well. Further, embodiments of the invention are suitable for use in connection with a variety of data rates such as about 1 Gbps, about 2 Gbps, about 4 Gbps, and about 10 Gbps, or higher.

FIG. 1 depicts lens pins 106 and 108, lens block 103, and fabricated package 101. Generally, fabricated packages, lens blocks, and lens pins can be fabricated (e.g., molded, machined, cast, etc.) from plastic, metal, or any other suitable material. Thus, for example, lens block 103 can be a molded plastic part. As depicted, lens block 103 is configured as a TX/RX lens block. That is, lens block 103 includes receptacle 132 for mechanically coupling to a transmission lens pin and receptacle 131 for mechanically coupling to a reception lens pin. Accordingly, lens block 103 facilitates both transmitting and receiving an optical signal.

However, lens block 103 or a similar lens block can be configured differently than depicted in FIG. 1. In some embodiments, lens block 103 or a similar lens block is configured as a separate lens block with reduced functionality. For example, lens block 103 or a similar lens block can be configured as a separate TX lens block for transmitting an optical signal or can be configured as a separate RX lens block for receiving an optical signal. In these embodiments, lens block 103 or a similar lens block can mechanically couple to a lens pin that facilitates the desired functionality (e.g., either transmitting an optical signal or receiving an optical signal).

In other embodiments, lens block 103 or a similar lens block is configured as a combination lens block with different combinations of functionality. For example, lens block 103 or a similar lens block can be configured to transmit a plurality of optical signals and/or receive a plurality of optical signals. Accordingly, lens block 103 or a similar lens block can include a plurality of receptacles for mechanically coupling to transmission lens pins and a corresponding plurality of receptacles for mechanically coupling to reception lens pins. Further, lens block 103 or a similar lens block can be configured as an unbalanced combination lens block. That is, the number of receptacles for mechanically coupling to transmission lens pins and the number of receptacles for mechanically coupling to reception lens pins can differ.

Lens block 103 may or may not include lens elements. For example, in some embodiments, lens elements are included in one or more of receptacles 131 and 132 and/or in one or more other appropriate receptacles based on lens block configuration. Included lens elements can be collimating lens elements. In other embodiments, no receptacles include lens elements.

Fabricated package 101 includes transmission opening 122 for transmitting generated optical signals. For example, VCSEL 151 (Vertical Cavity Surface Emitting Laser) can transmit optical signals out of transmission opening 122. Fabricated package 101 also includes detector opening 124 for detecting received optical signals. For example, photodiode 152 can detect optical signals received at detector opening 124. Components included in fabricated package 101 can be wire bonded to contacts of formed lead frame 107 extending into transmission opening 122 and detector opening 124. Accordingly, a light source and photo detector in fabricated package 101 can be electrically coupled to external circuitry. For example, formed lead frame 107 can be configured for connecting fabricated package 101 (both electrically and mechanically) to a PCB, such as, for example, a transceiver substrate.

Lens pins 106 and 108 can be slip fit into receptacles 131 and 132 respectively to facilitate directing optical signals between fabricated package 101 and corresponding external components (e.g., optical cable). Lens block 103 can be fit onto (e.g., placed flush against) fabricated package 101. Lens block 103 and fabricated package 101 can be held together using a variety of attachment means, such as, for example, epoxy, metal clips, or laser welding. Laser wielding can be particularly advantageous when lens block 103 and fabricated package 101 are made of similar plastic compounds. Lens pins (e.g., lens pins 108 and 106) can be held to lens block 103 using similar attachment means.

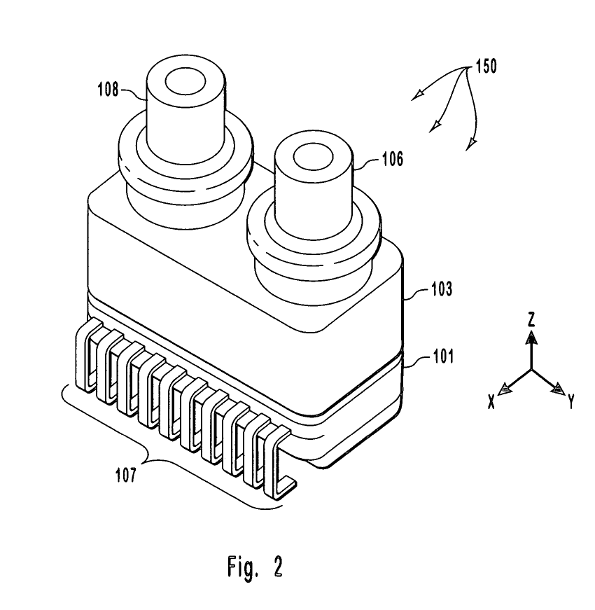

FIG. 2 illustrates an example of an assembled modular optical device 150 with formed lead frame 107. Modular optical device 150 depicts components from FIG. 1 assembled into a modular optical device. That is, lens pins 106 and 108 are mechanically coupled to lens block 103 and lens block 103 is mechanically coupled to fabricated package 101.

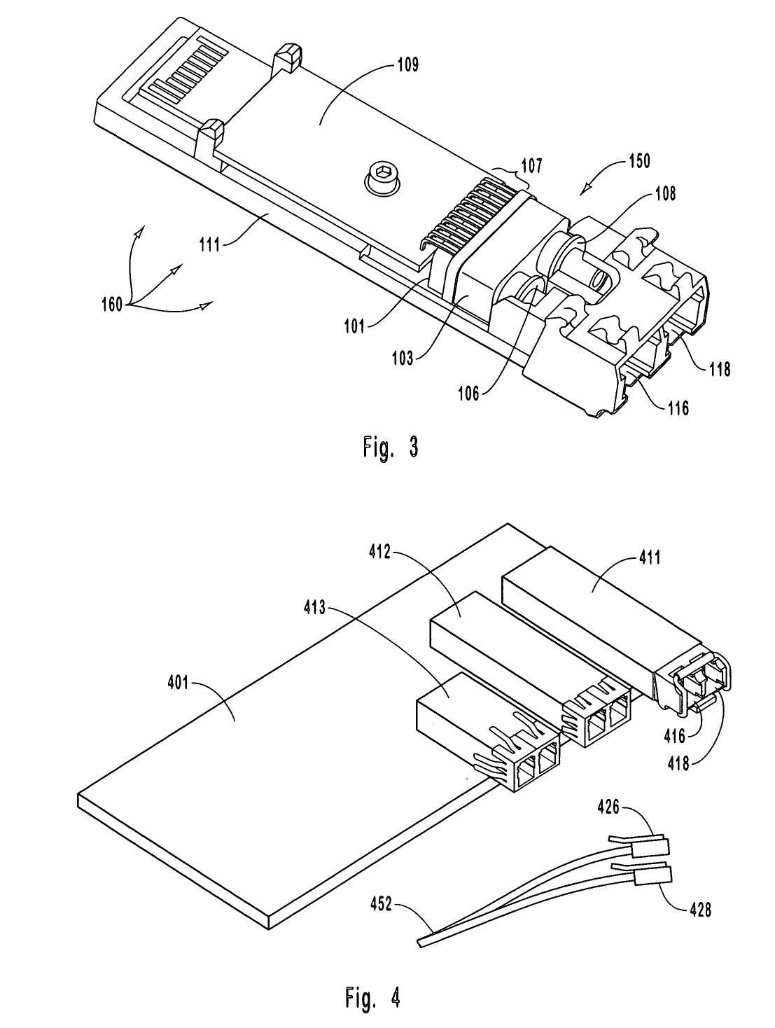

FIG. 3 illustrates an example view of an assembled modular optical device 150 included in optical transceiver 160. As depicted, external housing 111 is of an SFP outline. That is, the dimensions of external housing 111 are compliant with the SFP MultiSource Agreement (“MSA”). Accordingly, optical transceiver 160 can have similar fit, form, and functionality to other transceivers that comply with the SFP MSA. External housings can also be of other outlines, such as, for example, SFF and XFP outlines, and/or compliant with other MSAs.

External housing 111 includes ports 116 and 118 for receiving connections to other components, such as, for example, optical cables. External housing 111 has been formed such that substrate 109 and the components of modular optical device 150 can be received within external housing 111. Transceiver 160 can also have a second portion of external housing (not shown) that is secured on top of external housing 111 (e.g., after assembly) to protect the contained components.

As depicted in FIG. 3, formed lead frame 107 mechanically and an electrically couples to substrate 109. Accordingly, formed lead frame 107 facilitates electrical communication between circuitry (not shown) on substrate 109 and components (e.g., a light source and/or light detector) in fabricated package 101. Thus, formed lead frame 107 enables data transmission and/or reception, as well as the transmission and reception of control and monitoring signals, between fabricated package 101 and substrate 109 (or other appropriate components). Electrical communication can include communication between a light source included in fabricated package 101, such as, for example, a laser (e.g., a VCSEL) and a corresponding laser driver circuit on substrate 109. Likewise, electrical communication can include communication between a light detector included in fabricated package 101, such as, for example, a photodiode, and a corresponding transimpedance amplifier circuit on substrate 109.

Components (not shown), such as, for example, light emitting diodes, a laser driver, a post amplifier, a transimpedance amplifier, a current bias driver, volatile and/or non-volatile memory, and a thermo-electric cooler (“TEC”) can be implemented on substrate 109. Components can be implemented on either side of substrate 109 as appropriate. Implemented components can interface electrically with modular optical device 150 through formed lead frame 107. Mounting components, circuits and devices on both sides of substrate 109 can facilitate a compact structure without any meaningful loss in functionality.

Further, including circuitry for interoperating with light sources and light detectors on substrate 109 (or other appropriate medium) reduces the circuitry that is to be included in fabricated package 101. Accordingly, the number and size of components included in fabricated package 101 is reduced resulting in a cheaper more compact optical device. Additionally, the reduced size allows for production of relatively shorter transceivers that can be readily integrated within various devices.

Prior to assembly of transceiver 160, modular optical device 150 can be tested. Thus, if for any reason one or more of lens pin 106, lens pin 108, lens block 103, and fabricated package 101 do not appropriately interoperate, such inappropriate operation can be identified before transceiver 160 is assembled. Testing assembled modular optical device 150 increases the likelihood of identifying inappropriate operation before transceiver 160 is assembled. As a result, component resources are potentially conserved. That is, there is decreased likelihood of having to discard an assembled transceiver 160, which may include some appropriately functioning components (a substrate and external housing), due to a malfunction in the components of modular optical device 150.

Further, since modular optical device 150 is assembled to include formed lead frame 107, there is little, if any, need for using separate TOSA and ROSA connectors (e.g., flex circuit connectors). Thus, the cost of manufacturing a transceiver is potentially reduced.

FIG. 4 illustrates an example view of various transceivers 411, 412, and 413 positioned on a PCBA 401. Transceivers 411, 412, and 413 can be of various form factors, including, but not limited to SFP, SFF, and XFP form factors. Transceivers 411, 412, and 413 can contain assembled modular optical devices similar to modular optical device 150. The external housings of transceivers 411, 412, and 413 can include connectors for mechanically and electrically coupling the transceivers 411, 412, and 413 to PCBA 401. Accordingly, components contained in transceivers 411, 412, and 413 can interoperate with circuitry on PCBA 401 through the connectors.

The ports of transceivers 411, 412, and 413 (e.g., similar to ports 116 and 118) can be configured to receive any of a variety of connections, such as, for example, SC, LC, ST, and FC connectors. For example, the connectors 426 and 428 of optical cable 452 may be LC connectors that are received at ports 416 and 418 respectively.

PCBA 401 can include an edge connector (not shown) suitable for inserting PCBA 401 in a corresponding receptacle in a computer system, for example, to establish a mechanical and electrical interface between PCBA 401 and a corresponding computer system bus. Alternately, an edge or other type of connector (not shown) can facilitate establishment of a mechanical and electrical interface between PCBA 401 and a variety of other devices, such as, for example, an optical router or optical hub. After insertion into a computer system or other device, components on PCBA 401 can interoperate with components of the computer system or other device through the edge (or other type of) connector. For example, when PCBA 401 is inserted into a computer system or other device, transceivers 411, 412, and 413, can interface electrically with the computer system or other device. When appropriate, portions of circuitry otherwise implemented on substrate 109 can instead be implemented on PCBA 401.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes, which come within the meaning and range of equivalency of the claims, are to be embraced within their scope.

What is claimed and desired secured by United States Letters Patent is:

1. A modular optical device, comprising:
an external housing containing optical components, including:
a lens block configured such that one or more lens pins can mechanically couple to the lens block and such that the lens block can mechanically couple to a fabricated package;
a fabricated package mechanically coupled to the lens block, the fabricated package including at least one of a light source and a light detector, the fabricated package including a connector portion for connecting the fabricated package to a substrate; and
at least one lens pin mechanically coupled to the lens block, the at least one lens pin for directing an optical signal between the at least one of a light source and a light detector and at least one corresponding external component;
a substrate mechanically coupled to the fabricated package and the external housing and electrically connected to the at least one of a light source and a light detector such that circuitry on the substrate can electrically interoperate with the at least one of a light source and a light detector.

2. The modular optical device as recited in claim 1, wherein the external housing is of an SFF form factor.

3. The modular optical device as recited in claim 1, wherein the external housing is of an SFP form factor.

4. The modular optical device as recited in claim 1, wherein the external housing is of an XFP form factor.

5. The modular optical device as recited in claim 1, wherein the fabricated package includes a laser.

6. The modular optical device as recited in claim 1, wherein the fabricated package includes a photodiode.

7. The modular optical device as recited in claim 1, wherein the fabricated package is a plastic fabricated package.

8. The modular optical device as recited in claim 1, wherein the at least one lens pin mechanically coupled to the lens block is configured to direct an optical signal between the at least one of a light source and a light detector and a corresponding optical cable.

9. The modular optical device as recited in claim 1, further comprising an attachment portion that mechanically couples the lens block to the fabricated package, the attachment portion being selected from among epoxy, metal clips, and a laser weld.

10. An optoelectronic interface device comprising:
a host bus adapter having a printed circuit board with at least one connector for electrically interfacing with a host device; and
a modular optical device configured to mechanically and electrically interface with the host bus adapter, the modular optical device comprising:
a housing containing optical components, including:
a lens block configured such that that one or more lens pins can mechanically couple to the lens block and such that the lens block can mechanically couple to a fabricated package;
a fabricated package mechanically coupled to the lens block, the fabricated package including at least one of a light source and a light detector, the fabricated package including a connector portion for connecting the fabricated package to a substrate;
at least one lens pin mechanically coupled to the lens block, the at least one lens pin for directing an optical signal between the at least one of a light source and a light detector and at least one corresponding external component; and
a substrate mechanically coupled to the fabricated package and the external housing and electrically connected to the at least one of a light source and a light detector such that circuitry on the substrate can electrically interoperate with the at least one of a light source and a light detector.

11. The modular optical device as recited in claim 10, wherein the housing is of an SFF form factor.

12. The modular optical device as recited in claim 10, wherein the housing is of an SFP form factor.

13. The modular optical device as recited in claim 10, wherein the housing is of an XFP form factor.

14. The optoelectronic interface device as recited in claim 10, wherein the host bus adapter includes components for converting between an optical signal and an electrical signal.

15. The optoelectronic interface device as recited in claim 10, wherein the optoelectronic interface device is configured to be substantially received within a standard slot of the host device, the host device selected from among a desktop computer, a laptop computer, an optical hub, and an optical router.

16. The optoelectronic interface device as recited in claim 15, wherein the standard slot comprises one of: a PCI card slot and a PCMCIA card slot.

17. The optoelectronic interface device as recited in claim 10, wherein the host bus adapter comprises a printed circuit board for one of: a peripheral component interconnect card and a PCMCIA card.

18. A modular optical device comprising:
an external housing containing optical components, including:
a lens block configured such that a plurality of lens pins can mechanically couple to the lens block and such that the lens block can mechanically couple to a fabricated package;
a fabricated package mechanically coupled to the lens block, the fabricated package including a laser and a photodiode, the fabricated package including a connector for connecting the fabricated package to a substrate;
a substrate mechanically coupled to the fabricated package and the external housing and electrically connected to the laser and the photodiode via the connector such that circuitry on the substrate can electrically interoperate with the laser and the photodiode;
a first lens pin mechanically coupled to the lens block for directing an optical signal from the laser to an external component; and
a second lens pin mechanically coupled to the lens block for directing an optical signal from an external component to the photodiode.

19. The modular optical device as recited in claim 18, wherein the laser is a vertical cavity surface emitting laser.
